(19) United States
(12) Patent Application Publication
(10) Pub. No.: US 2019/0391395 A1
(43) Pub. Date: Dec. 26, 2019

(54) HEAD-MOUNTED DISPLAY AND IMAGE PROCESSING METHOD

(71) Applicant: Tyffon Inc., Camden, DE (US)

(72) Inventor: Takeshi FUKAZAWA, Tokyo (JP)

(73) Assignee: Tyffon Inc., Camden, DE (US)

(21) Appl. No.: 16/445,396

(22) Filed: Jun. 19, 2019

(30) Foreign Application Priority Data
Jun. 20, 2018 (JP) 2018-116585

(51) Int. Cl. G02B 27/01; H04N 5/225; H04N 5/232

(52) U.S. Cl. CPC G02B 27/0172; G02B 2027/0178; H04N 5/23229; H04N 5/2253

(57) ABSTRACT

An additional service that can make eating more enjoyable for a customer in an eating facility is provided. A head-mounted display which is worn by a customer in a facility in which food is offered includes: a display unit that displays image content; an acquisition unit that sequentially acquires an image of predetermined food which is captured by an imaging device; a determination unit that determines whether the image of the food acquired at the time of second acquisition by the acquisition unit varies from the image of the food acquired at the time of first acquisition by the acquisition unit; and an image processing unit that adds a first predetermined variation to the image content when the determination unit has determined that the image of the food acquired at the time of second acquisition varies from the image of the food acquired at the time of first acquisition.

### CROSS-REFERENCE TO RELATED APPLICATION(S)

This application claims priority under 35 U.S.C. § 119 to Japanese Patent Application No. 2018-116585, filed Jun. 20, 2018, the entire contents of which are incorporated herein by reference.

### BACKGROUND

### Field

One or more example embodiments relate to a head-mounted display and an image processing method.

### Description of Related Art

In the related art, several systems that provide entertainment such as games so that a waiting time until a table is set or a time after dinner in a facility in which food is offered such as a restaurant can be meaningfully spent have been proposed.

For example, a system that can execute a game on a screen by setting a game with a display such as a menu as a game element in a playing form or the form of a prize competition or a quiz in a management computer in advance and allowing a user to touch a game display which is displayed on a touch screen installed in a table of a restaurant is disclosed (for example, see Patent Document 1).

Most entertainment which is provided in facilities such as restaurants is meant to be enjoyed before and after eating, which includes during payment (for example, see Patent Document 2).

### PATENT DOCUMENTS

[Patent Document 1] Japanese Unexamined Patent Application Publication No. 2003-317155
[Patent Document 2] Japanese Unexamined Patent Application Publication No. 2004-057212

### SUMMARY

However, with recent increases in the numbers of customers who visit cafeterias and restaurants alone, there is demand for providing customers with high satisfaction with their food by providing additional services which can allow customers to enjoy their meals more even while eating.

Therefore, one or more example embodiments provide a head-mounted display and an image processing method which can make eating more enjoyable for a customer.

According to at least one example embodiment, there is provided a head-mounted display which is worn by a customer in a facility in which food is offered, the head-mounted display including: a display unit configured to display image content; an acquisition unit configured to sequentially acquire an image of predetermined food which is captured by an imaging device; a determination unit configured to determine whether the image of the food acquired at the time of second acquisition by the acquisition unit varies from the image of the food acquired at the time of first acquisition by the acquisition unit; and an image processing unit configured to add a first predetermined variation to the image content when the determination unit has determined that the image of the food acquired at the time of second acquisition varies from the image of the food acquired at the time of first acquisition.

According to an example embodiment, since a variation is added to an image included in moving image content while a customer eats, it is possible to make eating more enjoyable for a customer in a facility in which the customer eats such as a restaurant. According to an example embodiment, since a variation which is added to an image included in moving image content differs depending on various eating states or actions of a customer, it is possible to make eating a variety of foods more enjoyable for a customer.

### BRIEF DESCRIPTION OF THE DRAWINGS

FIG. 1 is a diagram schematically illustrating a head-mounted display according to an example embodiment;

FIG. 2 is a block diagram illustrating an example of a functional configuration of the head-mounted display according to the example embodiment;

FIGS. 3A to 3C are diagrams illustrating examples of an image in which identification information indicating a decreased amount of food is added to an image of food which is offered to a customer according to the example embodiment;

FIGS. 4A to 4C are diagrams illustrating examples of a decreased amount of food that is offered as a customer eats according to the example embodiment;

FIGS. 5A to 5D are diagrams illustrating examples of a predetermined variation which is added to a predetermined image included in moving image content according to the example embodiment;

FIG. 6 is a diagram illustrating an example of a variation adding rule according to the example embodiment;

FIG. 7 is a flowchart illustrating a flow of a process of adding a variation to an image of moving image content in the head-mounted display according to the example embodiment;

FIG. 8 is a flowchart illustrating a flow of a process of adding a variation to an image of moving image content in the head-mounted display when a customer's predetermined action has been detected according to the example embodiment;

FIG. 9 is a flowchart illustrating a flow of a process of adding a variation to an image of moving image content in the head-mounted display when a customer has finished eating according to the example embodiment; and

FIG. 10 is a hardware configuration diagram illustrating an example of a computer that can realize a control device according to the example embodiment.

### DETAILED DESCRIPTION

Hereinafter, a head-mounted display and an image processing method according to an example embodiment will be described with reference to the accompanying drawings. The scope of the claims should not be limited to the example embodiment.

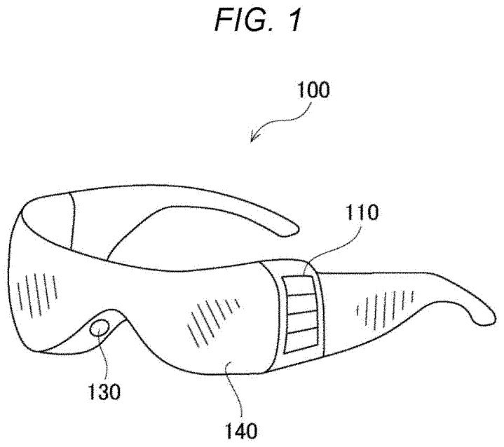

FIG. 1 is a diagram schematically illustrating a head-mounted display according to an example embodiment. As illustrated in FIG. 1, a head-mounted display 100 has a sunglasses shape and includes a control device 110, an imaging device (a camera) 130, and a display unit 140. The head-mounted display 100 is worn by a customer in a facility which provides food such as a restaurant or a cafeteria (hereinafter referred to as an eating facility). The shape of the head-mounted display 100 may be a shape other than the sunglasses shape such as a goggles shape.

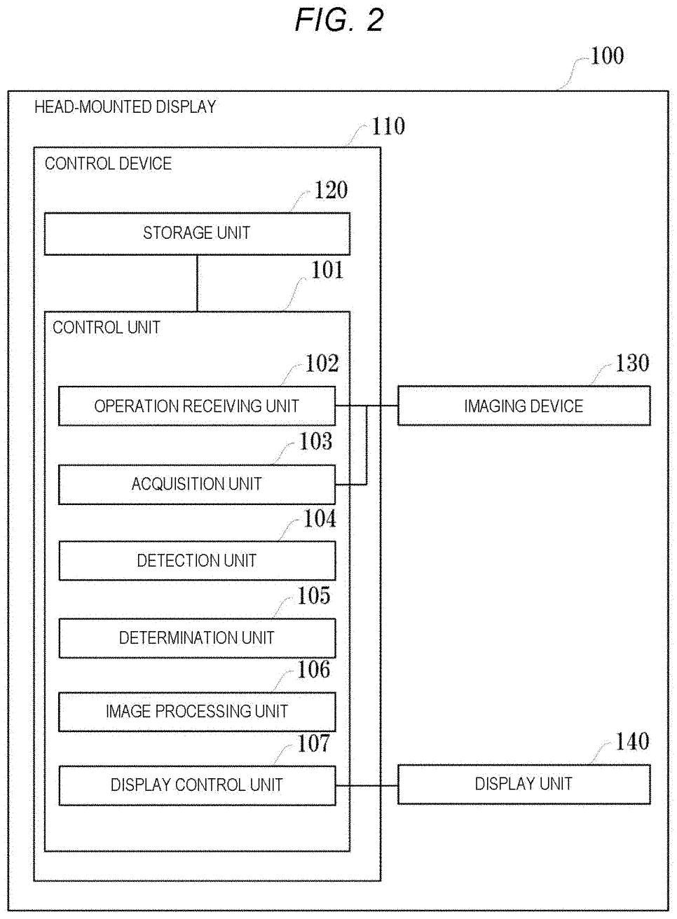

FIG. 2 is a block diagram illustrating an example of a functional configuration of the head-mounted display 100 according to the example embodiment. The functional configuration of the head-mounted display 100 will be described below with reference to FIG. 2.

As illustrated in FIG. 2, the head-mounted display 100 includes the control device 110, the imaging device 130, and the display unit 140.

The control device 110 includes a storage unit 120 and a control unit 101. A configuration in which the control device 110 is included in the head-mounted display 100 is employed in this example embodiment, but example embodiments are not limited thereto. For example, a configuration in which an external terminal (not illustrated) includes a control device 110 and a communication control unit (not illustrated), the head-mounted display 100 includes a communication control unit (not illustrated), and an image is output to the display unit 140 of the head-mounted display 100 by communication may be employed.

The storage unit 120 stores image content including images such as characters or scenery and a variation adding rule. Here, image content is data including a still image, a moving image, and sound and moving image content will be exemplified below in this example embodiment. A variation adding rule is a rule for determining a predetermined variation of an image of food offered to a customer or tableware on which food is placed (hereinafter referred to as tableware unless mentioned otherwise) which is acquired by the imaging device 130 or a predetermined variation which is added to a predetermined image included in moving image content and correlated with a customer's predetermined action. Here, a predetermined variation of an image of food or tableware is a variation in which food offered to a customer is decreased as the customer is allowed to eat the food. For example, a customer's predetermined action is an action of moving food to a position at which a character image included in moving image content is displayed with a spoon or the like to distribute the food to the character.

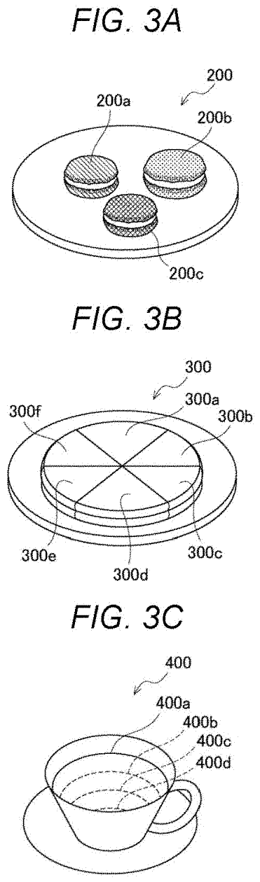

FIGS. 3A to 3C are diagrams illustrating examples of an image in which identification information indicating a decreased amount of food is added to an image of food which is offered to a customer. Images of food corresponding to menus which are offered by an eating facility are stored in the storage unit 120 in advance, and information for identifying an amount of food which is decreased by allowing a customer to eat food is added to the images of food. FIG. 3A is a diagram illustrating an image at the time of offering macarons, where three macarons including a macaron 200a with a hatched pattern, a macaron 200b with a dotted pattern, and a macaron 200c with a mesh pattern are placed on a dish of macarons 200. The macarons 200a to 200c are identified by different colors. For example, the macaron 200a may be red, the macaron 200b may be yellow, and the macaron 200c may be white. FIG. 3B is a diagram illustrating an image at the time of offering pancakes, where the pancakes 300 are marked as pancakes 300a to 300f to which solid lines indicating division into six parts are added. FIG. 3C is a diagram illustrating an image at the time of offering coffee, where scales 400a to 400d indicating a position of coffee in a coffee cup 400 are added to the coffee cup 400. In FIGS. 3A to 3C, signs are used as markers indicating a decreased amount of food, but example embodiments are not limited thereto. A two-dimensional code or pattern or the like may be added to each image indicating a decreased amount of food and identification may be performed by the codes or patterns.

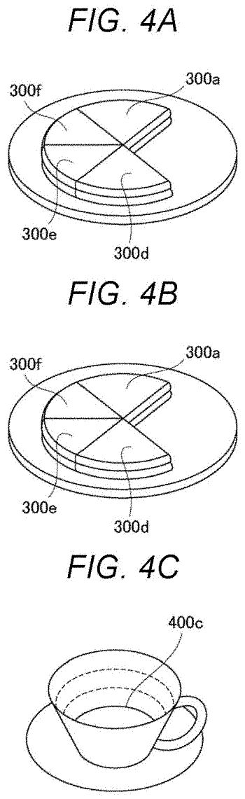

FIGS. 4A to 4C are diagrams illustrating examples of a decreased amount of food which is provided as a customer eats food. FIG. 4A illustrates a state in which the macaron 200b with a dotted pattern out of the macarons 200 illustrated in FIG. 3A has disappeared. FIG. 4B illustrates a state in which cuts of the pancake 300b and the pancake 300c out of the six divided pancakes 300 illustrated in FIG. 3B have disappeared. In FIG. 4C, the position of coffee in the coffee cup 400 illustrated in FIG. 3C indicates a state in which an amount of coffee indicated by the scale 400a in FIG. 3C has decreased to an amount of coffee indicated by the scale 400c.

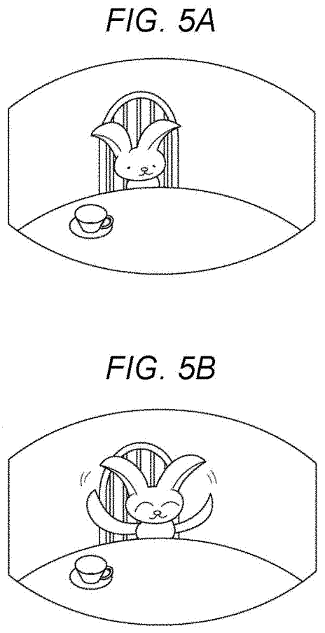

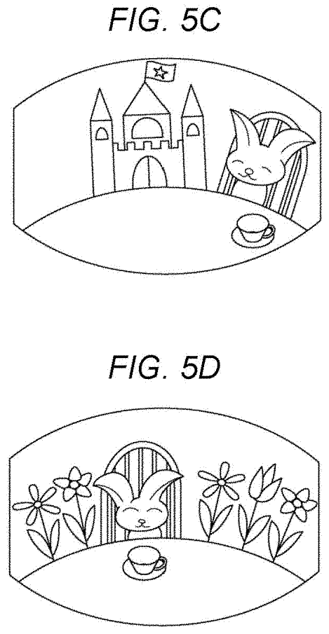

FIGS. 5A to 5D are diagrams illustrating examples of a predetermined variation which is added to a predetermined image included in moving image content. FIG. 5A is a diagram illustrating a state in which no variation is added to a character image included in the moving image content. For example, the moving image content is a moving image in which a character of a rabbit illustrated in FIG. 5A appears and eats food along with a customer, and an image in which the rabbit sits on a chair without expression is displayed at a time point at which food has been offered to the customer. FIG. 5B is a diagram illustrating a first variation which is added to the character image included in the moving image content. In FIG. 5B, the image of the rabbit is changed from the image illustrated in FIG. 5A to an image indicating happy expression and action along with a decrease in an amount of food due to the customer's eating food. FIG. 5C is a diagram illustrating a second variation which is added to the character image included in the moving image content. In FIG. 5C, when a predetermined action in which the customer moves the food to the rabbit has been detected, the image illustrated in FIG. 5A is changed to an image in which a castle appears in the background of the rabbit. FIG. 5D is a diagram illustrating a third variation which is added to the character image included in the moving image content. In FIG. 5D, when it is detected that the customer has finished eating food offered to the customer has been detected, the image illustrated in FIG. 5A is changed to an image in which flowers are blooming around the rabbit. These variations which are added to the image are only examples and may be various types of variations such as a variation in which the rabbit talks about a predetermined story and a variation in which the number of characters increases.

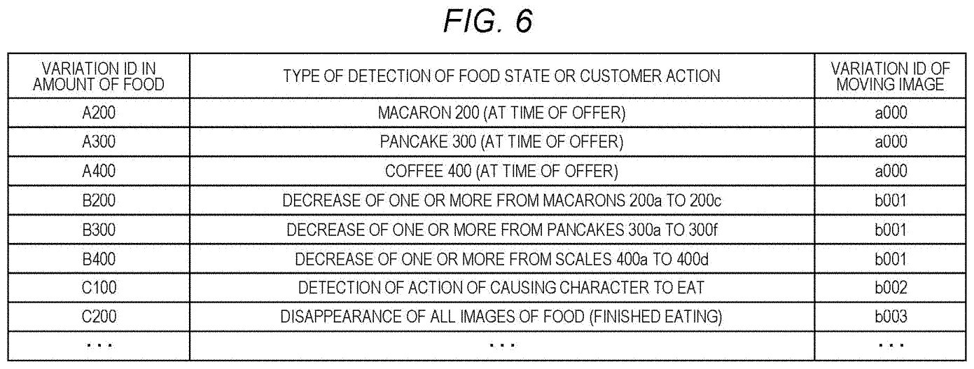

FIG. 6 is a diagram illustrating an example of a variation adding rule. As illustrated in FIG. 6, a variation ID of a moving image is correlated with a variation ID of an amount of food indicating an image state of food or tableware. In the variation adding rule illustrated in FIG. 6, a variation ID of a moving image in a state in which an amount of food has not varied (at the time of offering) is defined as “a000” (FIG. 3A illustrating no variation), a variation ID of the moving image in a state in which an amount of food has decreased by a predetermined amount (at the time of offering) is defined as “b001” (FIG. 3B illustrating a first variation), a variation ID of the moving image when an action of moving food to the character has been detected is defined as “b002” (FIG. 3C illustrating a second variation), a variation ID of the moving image when all food images have disappeared (at the time of finishing eating) is defined as “b003” (FIG. 3D illustrating a third variation), and a variation of food is classified into three types. For example, a variation ID “A200” of the amount of food indicating the image state “macarons 200 (at the time of offering)” of food or tableware is correlated with the variation ID “a000” of the moving image to which a variation of the moving image has not been added, and a variation ID “B200” of the amount of food indicating an image state of food or tableware in which “one of the macarons 200a to 200c has disappeared” is correlated with the variation ID “b001” of the moving image indicating that a variation is added to the moving image. In the storage unit 120, an image of food or tableware indicating a state which has been offered to the customer and images indicating that the amount of food has decreased by a predetermined amount are stored. A predetermined variation in moving image content is a predetermined variation which is added to an image included in the moving image content. Predetermined identification information is not particularly limited as long as it can identify a decrease in an amount of food, and a two-dimensional code or pattern or the like may be used. In this example embodiment, the variation of a moving image is classified into three types, but may be classified into one type or may be classified into more types.

The control unit 101 includes an operation receiving unit 102, an acquisition unit 103, a detection unit 104, a determination unit 105, an image processing unit 106, and a display control unit 107.

The operation receiving unit 102 receives an operation of turning on or off a power supply button (not illustrated) of the head-mounted display 100 from a user such as an employee or a customer. When a plurality of pieces of moving image content are stored in the storage unit 120, the operation receiving unit 102 receives selection of moving image content which are to be watched out of the plurality of pieces of moving image content.

When an operation of turning on a power supply button has been received by the operation receiving unit 102, the display control unit 107 outputs moving image content stored in the storage unit 120 to the display unit 140 to display the moving image content. The display control unit 107 outputs an image in which a variation has been added to an image of the moving image content and which has been generated by the image processing unit 106 to the display unit 140.

The display unit 140 is a glass-shaped lens in the head-mounted display 100 and an image (image content) is projected onto the lens. For example, a configuration in which an image is generated by an image generating element (for example, a see-through OLED display) or the like disposed in the lens serving as the display unit 140 and the generated image is displayed on the display unit 140 may be employed.

The imaging device 130 is a camera having a lens and is mounted in the vicinity of the display unit of the head-mounted display 100. The imaging device 130 may be mounted at any position of the head-mounted display 100 as long as it can capture an image of food on a table in which a customer eats food. The imaging device 130 may be mounted on the head-mounted display 100, but may be installed in an eating facility in which a customer's eating can be imaged.

The acquisition unit 103 sequentially and continuously acquires an image including food and tableware which is captured by the imaging device 130. Here, an image of food and tableware is sequentially and continuously acquired by the acquisition unit 103, but the times of acquisition are identified using terms a “time of first acquisition” and a “time of second acquisition” in description of whether an image of food varies below and the time point at which an image has been acquired is explicitly described. A time between the time of first acquisition and the time of second acquisition has only to be a predetermined time difference, and the time between the time of first acquisition and the time of second acquisition does not need to be a fixed time.

The detection unit 104 detects a customer's predetermined action which is imaged by the imaging device 130. For example, the detection unit 104 detects an action which is executed by a customer on a display image of moving image content such as an action of moving food to a position at which a character image included in the moving image content is displayed on the display unit 140 with a spoon or the like and distributing the food to the character.

The determination unit 105 determines whether an image acquired at the time of second acquisition by the acquisition unit 103 varies from an image of food or an image of food included in an image of tableware (hereinafter collectively referred to as an image of food unless mentioned otherwise) acquired at the time of first acquisition by the acquisition unit 103. Specifically, the determination unit 105 determines whether an image of food at the time of second acquisition by the acquisition unit 103 varies from the image of food at the time of first acquisition by a variation corresponding to a variation ID in the amount of food which is registered in the variation adding rule stored in the storage unit 120.

The determination unit 105 determines whether a customer has finished eating. Specifically, the determination unit 105 determines that eating has been finished when no food is included in an image of tableware on which food is placed in an image acquired by the acquisition unit 103.

When the determination unit 105 has determined that the image of food at the time of second acquisition varies from the image of food acquired at the time of first acquisition by the acquisition unit 103 to correspond to the variation ID of the amount of food, the image processing unit 106 adds a predetermined variation to the moving image content. Specifically, the image processing unit 106 acquires a variation ID of a moving image correlated with a variation ID of the amount of food, which is registered in the variation adding rule, and generates an image to which a variation of a moving image identified by the acquired variation ID of the moving image has been added.

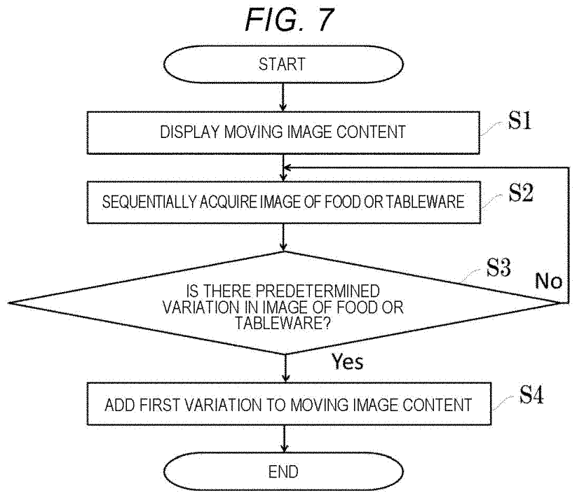

A process of adding a variation to an image of moving image content in the head-mounted display 100 will be described below. FIG. 7 is a flowchart illustrating a flow of a process of adding a variation to an image of moving image content in the head-mounted display 100.

The display control unit 107 outputs display information of moving image content stored in the storage unit 120 to the display unit 140 to display the moving image content (Step S1). The acquisition unit 103 sequentially acquires an image of food or tableware which is placed on a customer's table using the imaging device 130 (Step S2).

The determination unit 105 determines whether the image of food or table ware acquired in Step S2 varies to correspond to a predetermined variation (Step S3). Specifically, the determination unit 105 compares an image acquired at the time of first acquisition and an image acquired at the time of second acquisition out of the images of food or tableware which are sequentially acquired in Step S2 and determines whether the amount of food indicated by the image acquired at the time of second acquisition has decreased from the amount of food indicated by the image acquired at the time of first acquisition by a predetermined amount.

When the determination unit 105 has determined that there is a predetermined variation in the image of food or tableware in Step S3 (YES in Step S3), the image processing unit 106 adds a first variation to a predetermined image included in the moving image content (Step S4). Specifically, the image processing unit 106 generates the image illustrated in FIG. 3B corresponding to the variation ID “b001” of the moving image with reference to the variation adding rule and the display control unit 107 displays the generated image on the display unit 140. On the other hand, when the determination unit 105 has determined that there is no predetermined variation in the image of food or tableware in Step S3 (NO in Step S3), the process flow is returned to Step S2 and continues to progress.

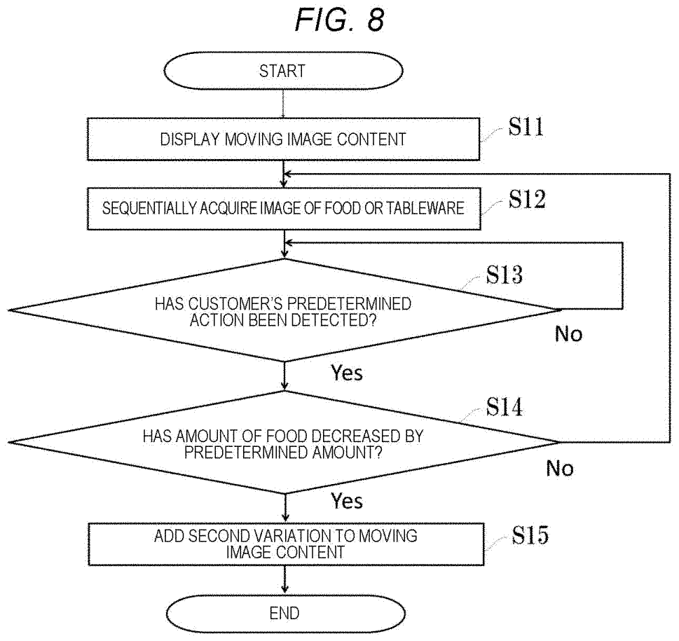

A process of adding a variation to an image of moving image content in the head-mounted display 100 when a customer's predetermined action has been detected will be described below. FIG. 8 is a flowchart illustrating a flow of a process of adding a variation to an image of moving image content in the head-mounted display 100 when a customer's predetermined action has been detected.

The display control unit 107 outputs display information of moving image content stored in the storage unit 120 to the display unit 140 to display the moving image content (Step S11). The acquisition unit 103 sequentially acquires an image of food or tableware which is placed on a customer's table (Step S12).

The determination unit 105 determines whether a customer's predetermined action has been detected by the detection unit 104 (Step S13). When it has been determined in Step S13 that the customer's predetermined action has been detected by the detection unit 104 (YES in Step S13), the determination unit 105 determines whether there is a predetermined variation in the image of food or tableware acquired by the acquisition unit 103 in Step S12 (Step S14). Specifically, the determination unit 105 compares the image acquired at the time of first acquisition and the image acquired at the time of second acquisition out of the images of food or tableware which are sequentially acquired in Step S13 with reference to the variation adding rule, and determines whether the amount of food indicated by an image acquired at the time of second acquisition has decreased from the amount of food indicated by the image acquired at the time of first acquisition by a predetermined amount. On the other hand, when the determination unit 105 has determined that the customer's predetermined action has not been detected by the detection unit 104 in Step S13 (No in Step S13), the process of Step S13 continues to be performed again.

When the determination unit 105 has determined that there is a predetermined variation in the image of food or tableware in Step S14 (YES in Step S14), the image processing unit 106 adds a second variation to an image included in the moving image content (Step S15). Specifically, the image processing unit 106 generates the image illustrated in FIG. 3C corresponding to the variation ID “b002” of the moving image with reference to the variation adding rule and the display control unit 107 displays the generated image on the display unit 140. On the other hand, when the determination unit 105 has determined that there is no predetermined variation in the image of food or tableware in Step S14 (NO in Step S14), the process flow is returned to Step S12 and continues to progress.

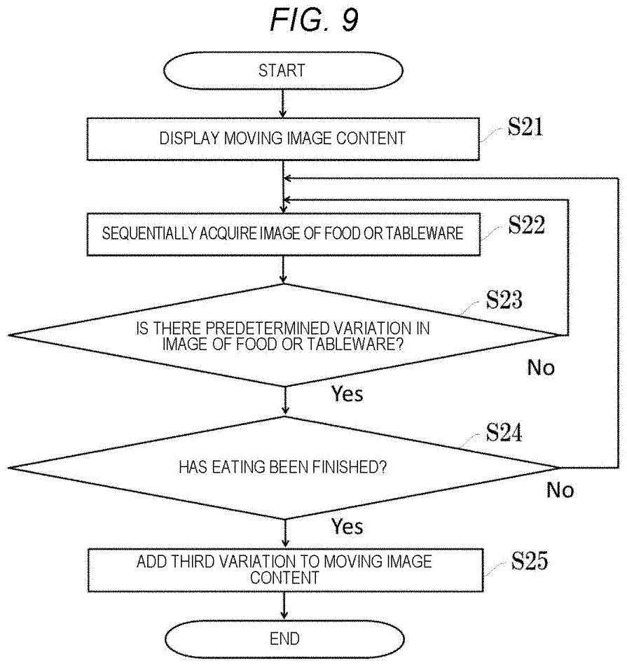

A process of adding a variation to an image of moving image content in the head-mounted display 100 when a customer has finished eating will be described below. FIG. 9 is a flowchart illustrating a flow of a process of adding a variation to an image of moving image content in the head-mounted display 100 when a customer has finished eating.

The display control unit 107 outputs display information of the moving image content stored in the storage unit 120 to the display unit 140 to display the moving image content (Step S21). The acquisition unit 103 sequentially acquires an image of food or tableware which is placed on a customer's table (Step S22).

The determination unit 105 determines whether there is a predetermined variation in the image of food or tableware acquired in Step S22 (Step S23). Specifically, the determination unit 105 compares the image acquired at the time of first acquisition and the image acquired at the time of second acquisition out of the images of food or tableware which are sequentially acquired in Step S22 with reference to the variation adding rule and determines whether the amount of food indicated by the image acquired at the time of second acquisition has decreased from the amount of food indicated by the image acquired at the time of first acquisition by a predetermined amount.

When the determination unit 105 has determined that there is a predetermined variation in the image of food or tableware in Step S23 (YES in Step S23), the determination unit 105 determines whether eating has ended (Step S24). Specifically, the determination unit 105 determines that eating has ended when no food is included in the image of tableware on which food has been placed in the image acquired by the acquisition unit 103. When the determination unit 105 has determined that eating has ended in Step S24 (YES in Step S24), the image processing unit 106 adds a third variation to a predetermined image which is included in the moving image content (Step S25). Specifically, the image processing unit 106 generates the image illustrated in FIG. 3D corresponding to the variation ID “b003” with reference to the variation adding rule and the display control unit 107 displays the generated image on the display unit 140. On the other hand, in Step S23, when the determination unit 105 has determined that there is no predetermined variation in the image of food or tableware in Step S23 (NO in Step S23) and has determined that eating has not ended in Step S24 (NO in Step S24), the process flow returns to Step S22 and continues to progress.

While an example embodiment has been described above, when a plurality of customers sit on the same table in another example embodiment, moving images which are displayed on the display units 140 of the head-mounted displays 100 for the plurality of customers may interlink with each other. In this case, an action of one customer may be reflected in display on the display unit 140 of the head-mounted display 100 of another customer or a specific story may be developed by a plurality of customers' specific action. When a plurality of customers sit on the same table, determination accuracy by the determination unit 105 may be improved by using a plurality of images captured by the imaging devices 130 thereof.

In another example embodiment, a configuration in which some functions of the head-mounted display 100 according to this example embodiment are executed by an external server may be employed. For example, the head-mounted display 100 captures an image using the imaging device 130 and transmits the captured image to an external server, and the external server determines the state of food. Then, the external server generates an image based on the determination result and transmits the generated image to the head-mounted display 100, and the head-mounted display 100 displays the image.

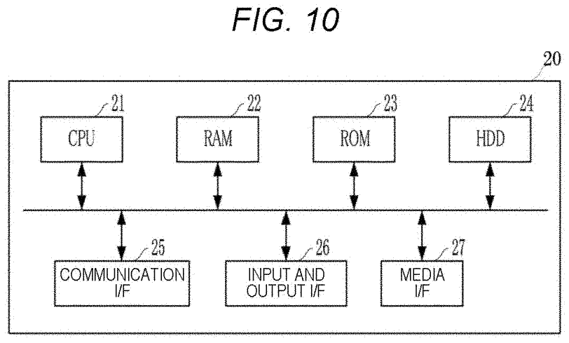

FIG. 10 is a hardware configuration diagram illustrating an example of a computer 20 that can realize the control device 110 according to this example embodiment. As illustrated in FIG. 10, the computer 20 includes a central processing unit (CPU) 21, a random access memory (RAM) 22, a read only memory (ROM) 23, a hard disk drive (HDD) 24, a communication interface (I/F) 25, an input and output interface (I/F) 26, and a media interface (I/F) 27.

The CPU 21 operates in accordance with a program stored in the ROM 23 or the HDD 24 and controls the units. The ROM 23 stores a booting program which is executed by the CPU 21 at the time of starting of the computer 20, a program depending on hardware of the computer 20, and the like.

The HDD 24 stores a program which is executed by the CPU 21, data which is used for the program, and the like. The communication interface 25 transmits data received from an external device via a communication line to the CPU 21 and transmits data generated by the CPU 21 to an external device via the communication line.

The CPU 21 controls an output device such as the display unit 140 and an input device such as a power supply button (not illustrated) via the input and output interface 26. The CPU 21 acquires data from the input device via the input and output interface 26. The CPU 21 outputs the generated data to the output device via the input and output interface 26.

The media interface 27 reads a program or data stored in a storage medium 28 and supplies the read program or data to the CPU 21 via the RAM 22. The CPU 21 loads the program from the storage medium 28 to the RAM 22 via the media interface 27 and executes the loaded program. Examples of the storage medium 28 include an optical storage medium such as a digital versatile disc (DVD), a magnetic storage medium, and a semiconductor memory.

When the computer 20 functions as the control device 110 in this example embodiment, the CPU 21 of the computer 20 realizes the functions of the operation receiving unit 102, the acquisition unit 103, the detection unit 104, the determination unit 105, the image processing unit 106, and the display control unit 107 by executing a program loaded onto the RAM 22. Data such as the variation adding rule is stored in the HDD 24.

An image processing program is a file with an installable format or an executable format and is stored and provided in a computer-readable storage medium such as a CD-ROM, a CD-R, a memory card, a digital versatile disk (DVD), or a flexible disk (FD). The CPU 21 of the computer 20 reads the programs from the storage medium via the media interface 27 and executes the read programs but, for example, may acquire such programs from an external device via a communication line.

A transaction management program can be mounted, for example, using a script language such as ActionScript, JavaScript (registered trademark), Python, or Ruby or a compiler language such as a C language, C++, C#, Objective-C, Swift, or Java (registered trademark).

As described above, with the head-mounted display 100 according to this example embodiment, since an additional service varying with eating food is provided, it is possible to enjoy a customer's eating food in an eating facility better.

### EXPLANATION OF REFERENCES

100 Head-mounted display
101 Control unit
102 Operation receiving unit
103 Acquisition unit
104 Detection unit
105 Determination unit
106 Image processing unit
107 Display control unit
110 Control device
120 Storage unit
130 Imaging device
140 Display unit
200 Macaron
300 Pancake
400 Coffee

What is claimed is:

1. A head-mounted display configured to be worn by a customer in a facility in which food is offered, the head-mounted display comprising:
a display unit configured to display image content;
an acquisition unit configured to sequentially acquire an image of food which is captured by an imaging device;
a determination unit configured to determine whether the image of the food acquired at a time of second acquisition by the acquisition unit varies from the image of the food acquired at a time of first acquisition by the acquisition unit; and
an image processing unit configured to add a first variation to the image content when the determination unit has determined that the image of the food acquired at the time of second acquisition varies from the image of the food acquired at the time of first acquisition.

2. The head-mounted display according to claim 1, wherein
the acquisition unit is configured to acquire an image of the food or an image of tableware on which the food is placed,
the determination unit is configured to compare an amount of food in the image of the food or the tableware acquired at the time of first acquisition by the acquisition unit with an amount of food in the image of the food or the tableware acquired at the time of second acquisition, and to determine whether the amount of food at the time of second acquisition is less than the amount of food at the time of first acquisition, and
the image processing unit is configured to add a variation to the image content when the determination unit has determined at the time of second acquisition that the amount of food at the time of second acquisition is less than the amount of food at the time of first acquisition.

3. The head-mounted display according to claim 2, wherein
the acquisition unit is configured to acquire the image of the food or the image of the tableware including identification information for indicating the amount of food, and
the determination unit is configured to determine whether the amount of food indicated by the identification information included in the image of the food or the image of the tableware at the time of second acquisition acquired by the acquisition unit is less than the amount of food indicated by the identification information included in the image of the food or the image of the tableware at the time of first acquisition.

4. The head-mounted display according to claim 2, wherein
the acquisition unit is configured to acquire an image of a plurality of the foods which is identified by identification information or an image of the tableware in which the amount of food which is able to be identified by identification information appears,
the determination unit is configured to determine whether a number of pieces of food indicated by the identification information included in the image of the food or the amount of food indicated by the identification information included in the image of the tableware which is acquired at the time of first acquisition by the acquisition unit has decreased in the image of the food acquired at the time of second acquisition by the acquisition unit, and
the image processing unit is configured to add a variation to the image content when the determination unit has determined at the time of second acquisition that the number of pieces of food has decreased from the image of the food acquired at the time of first acquisition.

5. The head-mounted display according claim 1, wherein
the display unit is configured to display image content including a character image, and
the image processing unit is configured to add a variation of an expression or an action of the character image when the determination unit has determined at the time of second acquisition that the image of the food varies from the image of the food acquired at the time of first acquisition.

6. The head-mounted display according to claim 1, wherein
the display unit is configured to display image content including a story image, and
the image processing unit is configured to add development to the story image when the determination unit has determined at the time of second acquisition that the image of the food varies from the image of the food acquired at the time of first acquisition.

7. The head-mounted display according to claim 1, further comprising:
a detection unit configured to detect action by the customer, wherein
the determination unit is configured to determine whether the image of the food acquired at the time of second acquisition by the acquisition unit varies from the image of the food acquired at the time of first acquisition by the acquisition unit when the action has been detected by the detection unit.

8. The head-mounted display according to claim 1, further comprising:
a detection unit configured to detect an action of moving the food from tableware to a position at which a character image is displayed on the display unit, wherein
the determination unit is configured to determine whether the action of moving the food from the tableware to the position at which the character image is displayed on the display unit has been detected by the detection unit, and
the image processing unit is configured to add a variation to an expression or an action of the character image or to add a variation to the image content when the determination unit has determined that the action of moving the food from the tableware to the position at which the character image is displayed on the display unit has been detected.

9. The head-mounted display according to claim 1, wherein the imaging device is provided in the head-mounted display or the facility.

10. An image processing method in a head-mounted display configured to be worn by a customer in a facility in which food is offered, the image processing method comprising:
displaying image content;
acquiring an image of food which is captured by an imaging device;
determining whether the image of the food acquired at a time of second acquisition in the acquiring varies from the image of the food acquired at a time of first acquisition in the acquiring; and
adding a first variation to the image content when the determining determines that the image of the food acquired at the time of second acquisition varies from the image of the food acquired at the time of first acquisition.
